(19) United States
(12) Patent Application Publication
(10) Pub. No.: US 2017/0229102 A1
(43) Pub. Date: Aug. 10, 2017

(54) TECHNIQUES FOR DESCRIPTOR OVERLAY SUPERIMPOSED ON AN ASSET

(71) Applicant: PRYSM, INC., San Jose, CA (US)

(72) Inventor: William Mason Shewman, Noblesville, IN (US)

(21) Appl. No.: 15/424,746

(22) Filed: Feb. 3, 2017

Related U.S. Application Data
(60) Provisional application No. 62/292,179, filed on Feb. 5, 2016.

(51) Int. Cl. G09G 5/377; G09G 5/373; G06F 9/44; G06F 3/14; G06F 3/0483; G06F 3/0484

(52) U.S. Cl. CPC G09G 5/377; G06F 3/0483; G06F 3/04845; G06F 9/4445; G06F 3/1454; G09G 5/373

(57) ABSTRACT

A communication infrastructure transmits an asset display data structure to each appliance in a collaborative session for a shared workspace. The asset display data structure comprises asset information (comprising aspect ratio, asset position, asset size, and current page fields) that configures the display appearance of assets within the shared workspace. The asset display data structure further comprises overlay information (comprising overlay position, overlay size, and asset descriptor fields) that configures the display appearance of descriptor overlays within the shared workspace. Each descriptor overlay is configured to be displayed over a predetermined portion of the corresponding asset, the descriptor overlay displaying at least one metadata descriptor of the corresponding asset. Each appliance receives the asset display data structure and displays/renders the shared workspace and the assets and descriptor overlays contained therein according to the received asset display data structure.

### CROSS-REFERENCE TO RELATED APPLICATIONS

This application claims the benefit of United States provisional patent application titled “TECHNIQUES FOR METADATA SUPERIMPOSED ON AN ASSET,” filed on Feb. 5, 2016 and having Ser. No. 62/292,179. The subject matter of this related application is hereby incorporated herein by reference.

### BACKGROUND OF THE INVENTION

Field of the Invention

The present invention generally relates to displaying shared digital content and, more specifically, to techniques for a descriptor overlay superimposed on an asset.

Description of the Related Art

Currently, digital content may be shared across different computer devices using a variety of techniques. As a general matter, though, during a content sharing session (“collaborative session”), a shared workspace that includes various types of digital content (“assets”) may be simultaneously displayed on multiple computer devices at different physical locations. For example, the shared workspace may be simultaneously displayed on a local computer device (used by a local user) as well as one or more remote computer devices (used by one or more remote users). The assets included in the shared workspace typically can be accessed and used by the different participants in the collaborative session. Further, assets may be repositioned or resized and new assets may be added within the shared workspace by participants in the collaborative session. In that regard, when a given user interacts with a particular asset in the shared workspace during a collaborative session, the user's interactions with the asset are reflected or mirrored on each computer device that accesses and displays the shared workspace. For example, a local user may reposition or resize asset A within the workspace at a local computer device, where the new position or new size of asset A within the workspace is mirrored at each of the remote computer devices in the collaborative session.

A drawback with such conventional content sharing approaches can occur when there are a large number of assets in the shared workspace and/or a large number of user interactions with the assets that continually reposition or otherwise modify the assets during a collaborative session. In these situations, distinguishing between the different assets in the workspace during the collaborative session becomes increasingly difficult for the participants. This problem may also occur even when there are a limited number of assets and/or interactions with the assets in the shared workspace after one collaborative session ends and another collaborative session begins at some future time. In the second collaborative session, users may have difficulty remembering the various distinctions between the different assets in the workspace that were established during the first collaborative session.

To learn about an asset during a collaborative session, participants typically, are required to interact with the asset in some fashion. For example, a participant may have to right-click on a particular asset in the shared workspace and select a properties field to obtain information about the asset. Such interactions with an asset, however, can be distracting to participants and do not provide an ideal user experience in the collaborative session.

As the foregoing illustrates, what is needed in the art are more effective techniques for distinguishing digital assets in a shared workspace during collaborative sessions.

### SUMMARY OF THE INVENTION

Various embodiments of the present invention include a computer-implemented method for displaying asset descriptors in a shared workspace. The method includes retrieving an asset data structure associated with the shared workspace, the asset data structure comprising asset information and overlay information for a first asset of the shared workspace. The asset information specifies a display position and display size of the first asset within the shared workspace and the overlay information specifies a display position and display size of a first overlay on the first asset, the first overlay comprising at least one descriptor of the first asset. The method further includes, transmitting the asset data structure to a plurality of clients in a collaborative session for the shared workspace, wherein each client of the plurality of clients displays the shared workspace by displaying the first asset within the shared workspace and the first overlay on the first asset according to the received asset data structure.

At least one advantage of the disclosed technique is that descriptors for an asset of a shared workspace are superimposed on an asset as an overlay, thus providing exposed information describing the asset to a plurality of clients in a collaborative session.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a display system configured to implement one or more aspects of the present invention;

FIG. 2 is a conceptual diagram of a collaboration system configured to share content streams across display systems, according to various embodiments of the present invention;

FIG. 3 is a more detailed block diagram of the streaming infrastructure of FIG. 2, according to various embodiments of the present invention;

FIG. 4 is a more detailed block diagram of the messaging infrastructure of FIG. 2, according to one embodiment of the present invention;

FIG. 5 is a conceptual diagram of the collaboration system of FIG. 2 configured to display a descriptor overlay on an asset in a shared workspace, according to various embodiments of the present invention;

FIG. 6A is a conceptual diagram of an initial/first asset display data structure, according to various embodiments of the present invention;

FIG. 6B is a screenshot of a first temporal rendering of a workspace based on the first asset display data structure of FIG. 6A, according to various embodiments of the present invention;

FIG. 6C is a conceptual diagram of a second asset display data structure, according to various embodiments of the present invention;

FIG. 6D is a screenshot of a second temporal rendering of a workspace based on the second asset display data structure of FIG. 6C, according to various embodiments of the present invention;

FIG. 6E is a conceptual diagram of a third asset display data structure, according to various embodiments of the present invention;

FIG. 6F is a screenshot of a third temporal rendering of a workspace based on the third asset display data structure of FIG. 6E, according to various embodiments of the present invention; and

FIG. 7 sets forth a flow diagram of method steps for displaying descriptor overlays in a shared workspace, according to various embodiments of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

The following description is divided into two sub-sections. Section I is a system overview describing a collaborative appliance and collaboration system. Section II describes techniques for displaying a descriptor overlay on an asset in a shared workspace.

### System Overview

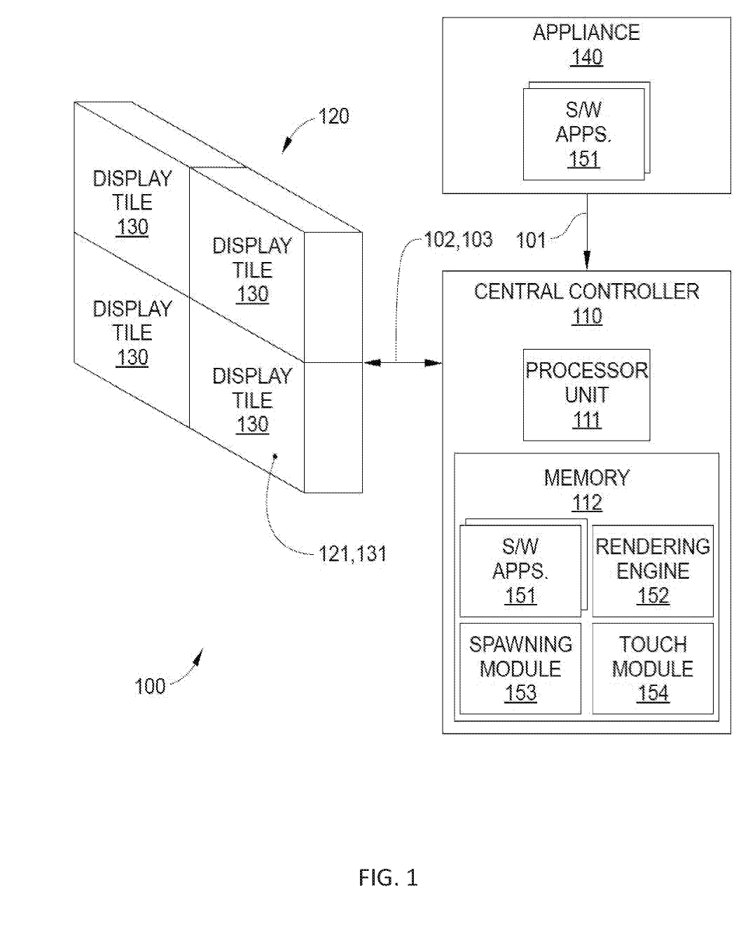

FIG. 1 is a block diagram of a display system 100 configured to implement one or more aspects of the present invention. As shown, display system 100 includes, without limitation, a central controller 110, a display 120, and an appliance/client 140. In some embodiments, display 120 is a display wall that includes multiple display tiles. Central controller 110 receives digital image content 101 from the appliance 140 or from an information network or other data routing device, and converts said input into image data signals 102. Thus, digital image content 101 may be generated locally, with appliance 140, or from some other location. For example, when display system 100 is used for remote conferencing, digital image content 101 may be received via any technically feasible communications or information network, wired or wireless, that allows data exchange, such as a wide area network (WAN), a local area network (LAN), a wireless (Wi-Fi) network, and/or the Internet, among others.

Central controller 110 includes a processor unit 111 and memory 112. Processor unit 111 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processor unit 111 may be any technically feasible hardware unit capable of processing data and/or executing program code and software applications to facilitate operation of display system 100, including software applications 151, rendering engine 152, spawning module 153, and touch module 154. The processor unit 111 executes software and performs the functions and operations described herein. During operation, software applications 151, rendering engine 152, spawning module 153, and touch module 154 may reside in memory 112. Alternatively or additionally, software applications 151 may also reside in appliance 140. In some embodiments, one or more of 151-154 may be implemented in firmware, either in central controller 110 and/or in other components of display system 100.

Memory 112 may include volatile memory, such as a random access memory (RAM) module, and non-volatile memory, such as a flash memory unit, a read-only memory (ROM), or a magnetic or optical disk drive, or any other type of memory unit or combination thereof. The memory unit 112 is configured to store software application(s) and data. Instructions from the software constructs within the memory unit 112 are executed by processors 111 to enable the inventive operations and functions described herein. Memory 112 is configured to store any software programs, operating system, drivers, and the like, that facilitate operation of display system 100, including software applications 151, rendering engine 152, spawning module 153, and touch module 154.

Display 120 may include the display surface or surfaces of any technically feasible display device or system type, including but not limited to the display surface of a light-emitting diode (LED) display, a digital light (DLP) or other projection displays, a liquid crystal display (LCD), optical light emitting diode display (©LED), laser-phosphor display (LPD) and/or a stereo 3D display all arranged as a single stand-alone display, head mounted display or as a single or multi-screen tiled array of displays. Display sizes may range from smaller handheld or head mounted display devices to full wall displays. In the example illustrated in FIG. 1, display 120 includes a plurality of display light engine and screen tiles 130 mounted in a 2×2 array. Other configurations and array dimensions of multiple electronic display devices, e.g. 1×4, 2×3, 5×6, etc., also fall within the scope of the present invention.

In operation, display 120 displays image data signals 102 output from controller 110. For a tiled display, as illustrated in FIG. 1, image data signals 102 are appropriately distributed among display tiles 130 such that a coherent image is displayed on a display surface 121 of display 120. Display surface 121 typically includes the combined display surfaces of display tiles 130. In addition, display 120 includes a touch-sensitive surface 131 that extends across part or all surface area of display tiles 130. In one embodiment, touch-sensitive surface 131 senses touch by detecting interference between a user and one or more beams of light, including, e.g., infrared laser beams. In other embodiments, touch sensitive surface 131 may rely on capacitive touch techniques, including surface capacitance, projected capacitance, or mutual capacitance, as well as optical techniques, acoustic wave-based touch detection, resistive touch approaches, and so forth, without limitation. Touch-sensitive surface 131 enables users to interact with assets displayed on the wall implementing touch gestures including tapping, dragging, swiping, and pinching. These touch gestures may replace or supplement the use of typical peripheral I/O devices, although touch-sensitive surface 131 may receive inputs from such devices, as well. In this regard, the display system 100 may also include typical peripheral I/O devices (not shown), such as an external keyboard or mouse, which also enable users to interact with assets.

In the context of this disclosure, an “asset” may refer to any interactive renderable digital content that can be displayed on a display, such as display 120, among others. Interactive renderable content is generally derived from one or more persistent or non-persistent content streams that include sequential frames of video data, corresponding audio data, metadata, flowable/reflowable unstructured content, and potentially other types of data. Generally, an asset may be displayed within a dynamically adjustable presentation window. For simplicity, an asset and corresponding dynamically adjustable presentation window are generally referred to herein as a single entity, i.e., an “asset.” An asset generally includes at least one display output generated by a software application, such as a GUI of the software application. In one embodiment, the display output is a portion of a content stream. In addition, an asset is generally configured to receive one or more software application inputs via a gesture-sensitive display surface of a collaboration appliance/client system 140, i.e., inputs received via the gesture-sensitive display surface are received by the asset and treated as input for the software application associated with the asset. Thus, unlike a fixed image, an asset is a dynamic element that enables interaction with the software application associated with the asset, for example, for manipulation of the asset. For example, an asset may include select buttons, pull-down menus, control sliders, etc. that are associated with the software application and can provide inputs to the software application.

In general, an asset may comprise a content source or a captured image of a content source. In particular, assets may comprise content sources that are file-based, application-based (e.g., web-based), or Live Source. For example, assets may include images, videos, web browsers, documents, applications, instances of applications, renderings of laptop screens, presentation slides, any other graphical user interface (GUI) of a software application, and the like. An asset may comprise a file-based source comprising any of a plurality of different of native file types (such as pdf, doc, xls, etc.). In further embodiments, an asset that is file-based may comprise an image file representation (e.g., JPEG representation) of the file, whereby a displayed page of the asset comprises an imaged representation of the asset. Further, an asset may comprise a captured image of any such content source described herein. In these embodiments, the asset comprises a static image of a content source captured, for example, using an image capture or screen capture function or application (such as SnapShot®).

An asset may also comprise digital content that is distributed over a single page or a plurality of pages (whereby the asset content is divided into a plurality of pages). In these embodiments, a single page among a total number of pages of the asset may be displayed at one time within the workspace (comprising the currently displayed page). For example, an asset may comprise a document comprising a plurality of different pages (the total number of pages), whereby one page of the document is displayed at one time within the workspace (the currently displayed page).

As also referred to herein, a “workspace” or “shared workspace” is a virtual digital canvas on which assets associated therewith, and their corresponding content streams, are displayed within a suitable dynamic “viewport window” on display 120. Thus, a shared workspace may comprise one or more associated assets (each asset displayed within a presentation window), whereby the entire shared workspace is displayed within a dynamically adjustable viewport window. A shared workspace may be displayed in the entire potential render area/space of the display 120, so that only a single shared workspace can be displayed on the surface thereof. In this case, the area of the viewport window that displays the shared workspace comprises the entire render area of the display 120. In other embodiments, however, the shared workspace and the viewport window may be displayed in a sub-area of the total display area of the display 120 that does not comprise the entire render area of the display 120. For example, multiple shared workspaces may be displayed in multiple viewport windows on the display 120 concurrently, whereby each shared workspace and viewport window does not correspond to the entire display surface. Each asset associated with a shared workspace, and content stream(s) corresponding to the asset, are displayed in a presentation window according to defined dimensions (height and width) and a location within the shared workspace and viewport window. The asset and presentation window dimensions and location may also be user-adjustable. As also referred to herein, a “project” may comprise a set of one or more related shared workspaces.

Touch-sensitive surface 131 may be a “multi-touch” surface, which can recognize more than one point of contact on display 120, enabling the recognition of complex gestures, such as two or three-finger swipes, pinch gestures, and rotation gestures as well as multiuser two, four, six etc. hands touch or gestures. Thus, one or more users may interact with assets on display 120 implementing touch gestures such as dragging to reposition assets on the screen, tapping assets to display menu options, swiping to page through assets, or implementing pinch gestures to resize assets. Multiple users may also interact with assets on the screen simultaneously. Again, examples of assets include application environments, images, videos, web browsers, documents, applications, instances of applications, mirroring or renderings of laptop screens, presentation slides, content streams, and so forth. Touch signals 103 are sent from a touch panel associated with a display 120 to central controller 110 for processing and interpretation.

It will be appreciated that the system shown herein is illustrative only and that variations and modifications are possible. For example, any of software applications 151, rendering engine 152, spawning module 153, and touch module 154 may reside outside of central controller 110.

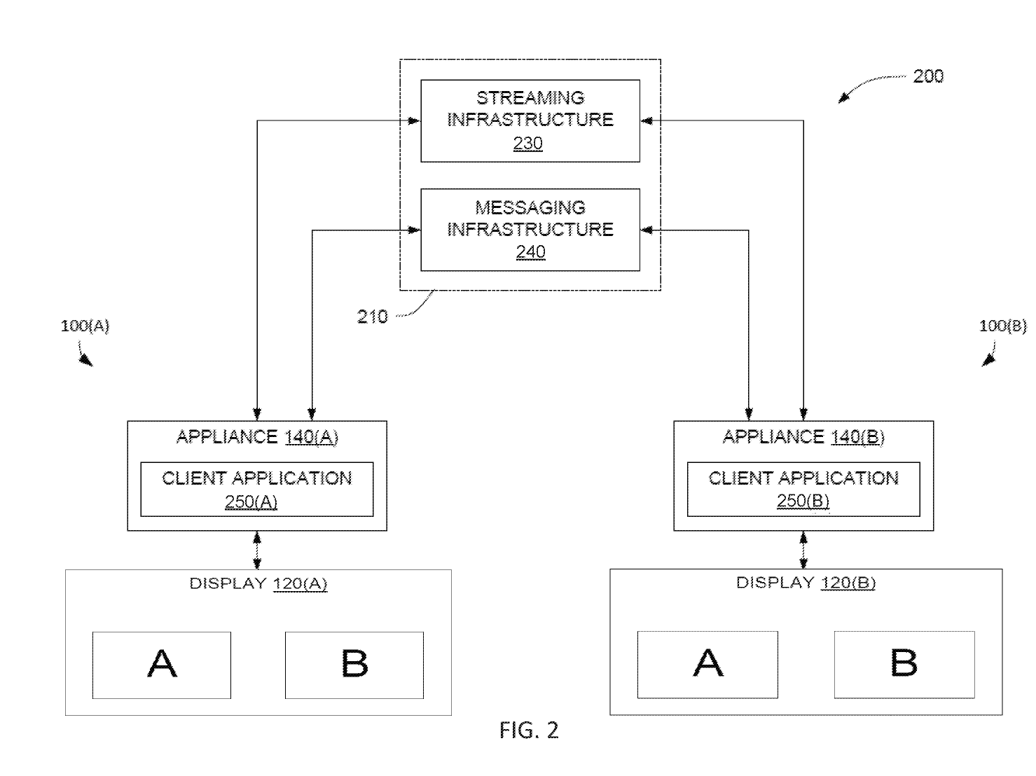

FIG. 2 is a conceptual diagram of a collaboration system 200 configured to share content streams across display systems, according to various embodiments of the present invention. As shown, collaboration system 200 includes, without limitation, display systems 100A and 100B coupled together via a communication infrastructure 210. As shown in FIG. 2, the communication infrastructure 210 includes streaming infrastructure 230 and messaging infrastructure 240. Additionally, display system 100A is shown to include appliance 140A as well as display 120A, and display system 100B is shown to include appliance 140B as well as display 120B. For illustrative purposes, the appliances 140A and 140B each include a central controller 110 (not shown). In one embodiment, each of displays 120A and/or 120B represents a different instance of display 120 of FIG. 1 Appliance devices 140A and 140B include client applications 250A and 250B, respectively.

Display system 100A is configured to share a content stream A, via communication infrastructure 210, with display system 100B. In response, display system 100B is configured to retrieve content stream A from communication infrastructure 210 and to display that content stream on display 120B with its content stream B. Likewise, display system 100B is configured to share content stream B, via communication infrastructure 210, with display system 100A. In response, display system 100A is configured to retrieve content stream B from communication infrastructure 210 and to display that content stream on display 120A with its content stream A. In this fashion, display systems 100A and 100B are configured to coordinate with one another to generate a shared workspace that includes content streams A and B. Content streams A and B may be used to generate different assets rendered within the shared workspace. In one embodiment, each of display systems 100A and 100B perform a similar process to reconstruct the shared workspace, thereby generating a local version of that shared workspace that is similar to other local versions of the shared workspace reconstructed at other display systems. As a general matter, the functionality of display systems 100A and 100B are coordinated by client applications 250A and 250B, respectively.

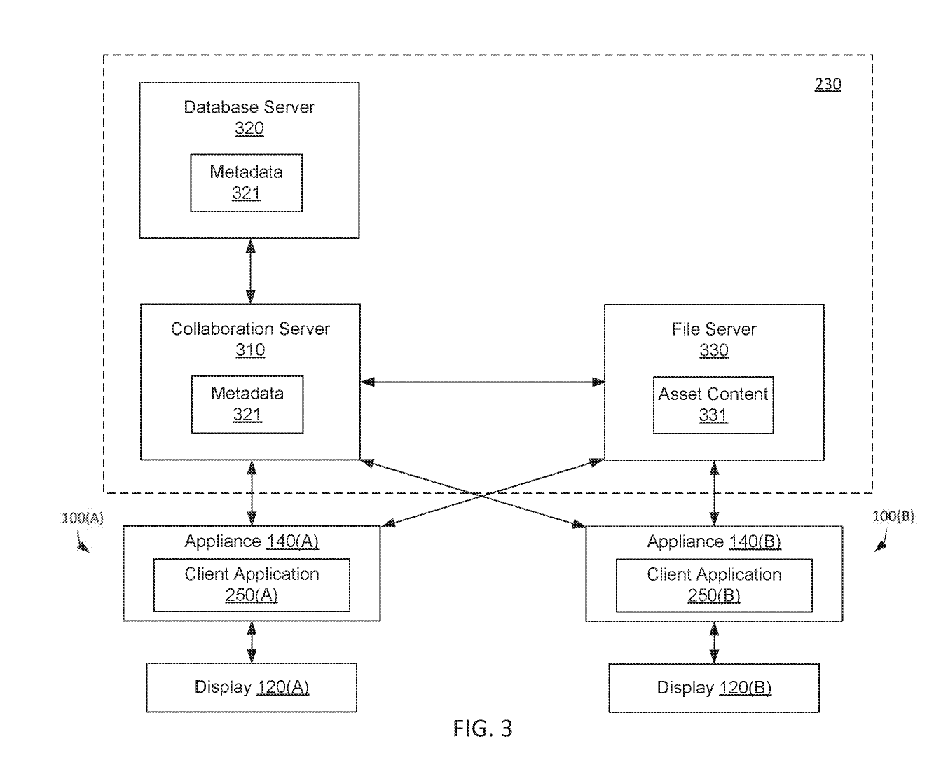

Client applications 250A and 250B are software programs that generally reside within a memory (not shown) associated with the respective appliances 140A and 140B. Client applications 250A and 250B may be executed by a processor unit (not shown) included within the respective computing appliances 140. When executed, client applications 250A and 250B setup and manage the shared workspace discussed above in conjunction with FIG. 2, which, again, includes content streams A and B. In one embodiment, the shared workspace is defined by metadata that is accessible by both display systems 100A and 100B. Each such display system 100 may generate a local version of the shared workspace that is substantially synchronized with the other local version, based on that metadata (discussed below in relation to FIG. 3).

In doing so, client application 250A is configured to transmit content stream A to streaming infrastructure 230 for subsequent streaming to display system 100B. Client application 250A also transmits a message to display system 100B, via messaging infrastructure 240, that indicates to display system 100B that content stream A is available and can be accessed at a location reflected in the message. In like fashion, client application 250E is configured to transmit content stream B to streaming infrastructure 230 for subsequent streaming to display system 100A. Client application 250B also transmits a message to display system 100A, via messaging infrastructure 240, that indicates to display system 100A that content stream B is available and can be accessed at a location reflected in the message. The message indicates that access may occur from a location within streaming infrastructure 230.

Client application 250A may also broadcast a message via messaging infrastructure 240 to display system 100E that specifies various attributes associated with content stream A that may be used to display content stream A. The attributes may include a location/position, a picture size, an aspect ratio, or a resolution with which to display content stream A on display 120B, among others, and may be included within metadata described below in relation to FIG. 3. Client application 250B may extract the attributes from messaging infrastructure 240, and then display content stream A at a particular position on display 120B, with a specific picture size, aspect ratio, and resolution, as provided by messaging infrastructure 240. Through this technique, display system 100A is capable of sharing content stream A with display system 100B. Display system 100B is configured to perform a complimentary technique in order to share content stream B with display system 100A.

Client applications 250A and 250B are thus configured to perform similar techniques in order to share content streams A and B, respectively with one another. When client application 250A renders content stream A on display 120A and, also, streams content stream B from streaming infrastructure 230, display system 100A thus constructs a version of a shared workspace that includes content stream A and B. Similarly, when client application 250B renders content stream B on display 120B and, also streams content stream A from streaming infrastructure 230, display system 100A similarly constructs a version of that shared workspace that includes content streams A and B.

The display systems 100A and 100B discussed herein are generally coupled together via streaming infrastructure 230 and messaging infrastructure 240. Each of these different infrastructures may include hardware that is cloud-based and/or collocated on-premises with the various display systems. However, persons skilled in the art will recognize that a wide variety of different approaches may be implemented to stream content streams and transport messages/messages between display systems.

FIG. 3 is a more detailed block diagram of the streaming infrastructure of FIG. 2, according to various embodiments of the present invention. Streaming infrastructure 230 may include a collaboration server 310, a database server 320, and a file server 330. Each server may comprise a computer device having a processor (such as processor unit 111 described in relation to FIG. 1) and a memory (such as memory 112 described in relation to FIG. 1), the processor executing software for performing functions and operations described herein. Collaboration server 310, database server 320, and file server 330 may be implemented as shown as separate and distinct computing devices/structures coupled to each other and to appliance systems 140 via a network. Alternatively, the functionality of collaboration server 310, database server 320, and file server 330 may be implemented as a single computing device/structure in a single location, or in any other technically feasible combination of structures. Further, one or more of collaboration server 310, database server 320, and/or file server 330 may be implemented as a distributed computing system. The network may be via any technically feasible communications or information network, wired or wireless, that allows data exchange, such as a wide area network (WAN), a local area network (LAN), a wireless (WiFi) network, and/or the Internet, among others.

Collaboration server 310 coordinates the flow of information between the various appliances 140, database server 320, and file server 330. Thus, in some embodiments, collaboration server 310 is a streaming server for appliances 140. In some embodiments, the application program interface (API) endpoint for appliances 140 and/or business logic associated with streaming infrastructure 230 resides in collaboration server 310. In addition, collaboration server 310 receives requests from appliances 140 and can send notifications to appliances 140. Therefore, there is generally a two-way connection between collaboration server 310 and each of appliances 140. Alternatively or additionally, appliances 140 may make requests on collaboration server 310 through the API. For example, during a collaborative work session on a particular project via collaboration system 200, a collaboration appliance 140 may send a request to collaboration server 310 for information associated with an asset to display the asset in a shared workspace of the particular project.

Database server 320 (as well as collaboration server 310) may store metadata 321 associated with collaboration system 200, such as metadata for specific assets, shared workspaces, and/or projects. For example, such metadata may include which assets are associated with a particular shared workspace, which shared workspaces are associated with a particular project, the state of various settings for each shared workspace, annotations made to specific assets, etc. Metadata 321 may also include asset metadata (also referred to as “asset information” herein) for each asset.

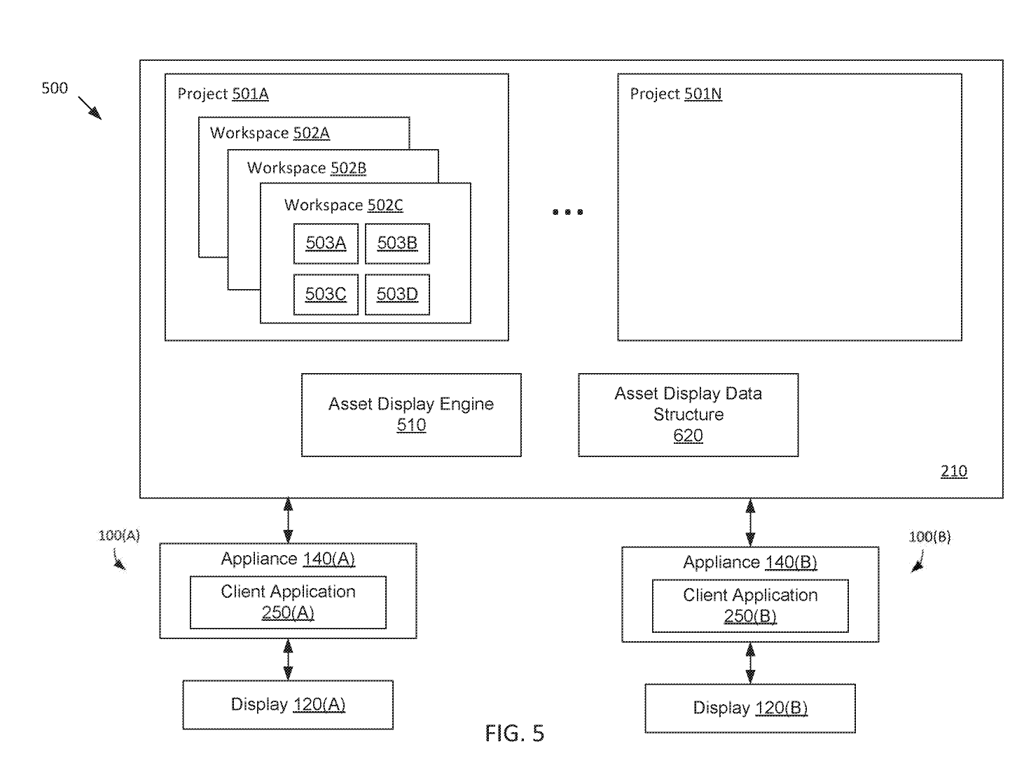

Asset metadata (asset information) for an asset may specify, for example, a display aspect ratio, a display location/position, and display dimensions/size of the asset within an associated shared workspace. The asset metadata may indicate an assigned aspect ratio for which to display the asset, such as a ratio of the width to the height of the asset. The asset metadata also indicates the display position and size of an asset, for example, implementing horizontal and vertical (x and y) coordinate values. In some embodiments, the asset metadata may express the position and size of an asset in percentage values. In such embodiments, the size (width and height) and position (x, y) of the asset is represented in terms of percent locations along an x-axis (horizontal axis) and y-axis (vertical axis) of the associated shared workspace. For example, the position and size of an asset may be expressed as percentages of the shared workspace width and shared workspace height. The horizontal and vertical (x and y) coordinate values may correspond to a predetermined point on the asset, such as the position of the upper left corner of the asset. When multiple display systems 100 separately display a shared workspace, each display system 100 may configure the local version of the shared workspace based on the received metadata. The asset metadata for displaying assets within a workspace may be stored to an asset display data structure, discussed below in relation to FIG. 5.

File server 330 is the physical storage location for some or all asset content 331 that are rendered as files, such as documents, images, videos, applications, and the like. In some embodiments, file server 330 can receive requests for asset content 331 directly from appliances 140. For example, an asset, such as a word-processing document, may be associated with a shared workspace that is displayed on the display 120 of first and second appliances 140. When the asset is modified by a user at the first collaboration appliance 140A (via client application 250A), metadata for a file associated with the asset is updated in file server 330 by collaboration server 310, the second collaboration appliance 140B (via client application 250B) downloads the updated metadata for the file from file server 330, and the asset is then displayed, as updated, on the gesture-sensitive display surface of the second collaboration appliance 140B (via client application 250B). Thus, file copies of all assets for a particular shared workspace and project may be stored at the file server 330, as well as stored at each appliance 140 that is collaborating on a project.

Each appliance 140 (executing a client application 250) is an instance of a collaborative multi-media platform disposed at a different location in collaboration system 200. Each collaboration appliance 140 is configured to provide a digital system that can be mirrored at one or more additional and remotely located appliances 140. The functionality of each appliance 140 participating in a collaboration is coordinated by the client application 250 which provides functions and features of collaborative sessions described herein. In this manner, collaboration clients facilitate the collaborative modification of assets, shared workspaces, and/or complete presentations or other projects, as well as the presentation thereof.

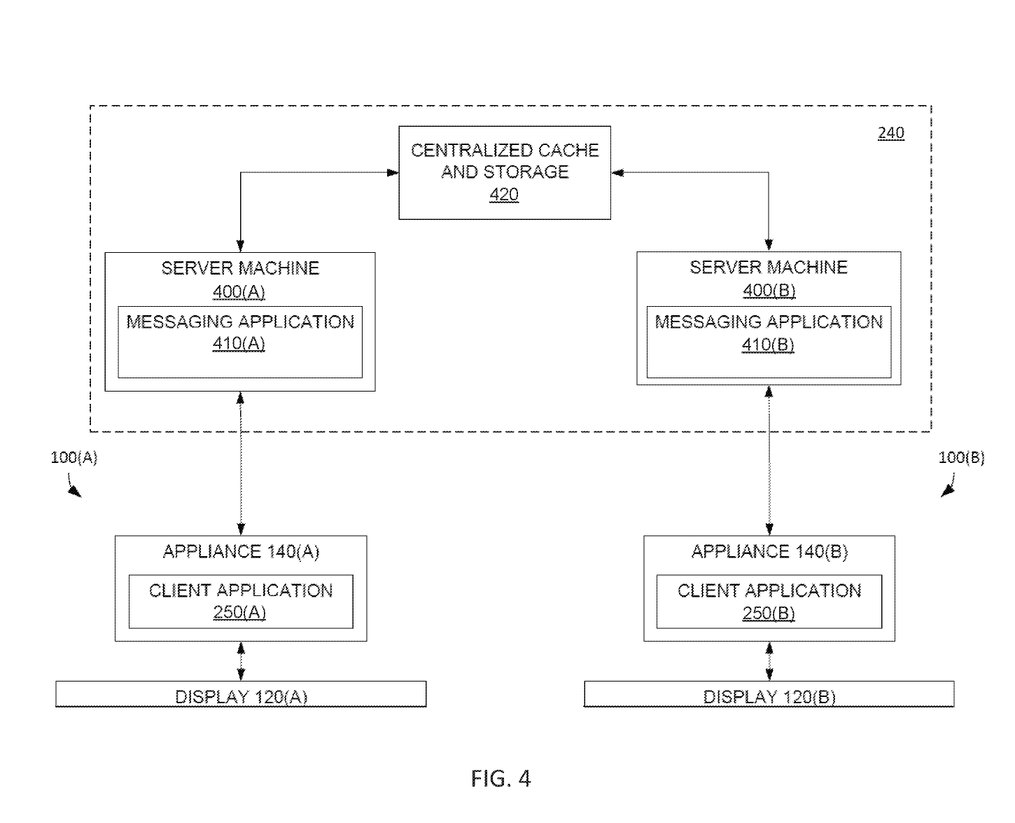

FIG. 4 is a more detailed block diagram of the messaging infrastructure of FIG. 2, according to one embodiment of the present invention. As shown, messaging infrastructure 240 includes server machines 400A and 400B coupled together via centralized cache and storage 420. Server machine 400A is coupled to appliance 140A and includes a messaging application 410A. Server machine 400B is coupled to appliance 140B and includes a messaging application 410B.

Server machines 400A and 400B are generally cloud-based or on-premises computing devices that include memory (such as memory 112 described in relation to FIG. 1) and processor units (such as processor unit 111 described in relation to FIG. 1) configured to store and execute messaging applications 410A and 410B, respectively. Messaging applications 410A and 410B are configured to generate real-time socket connections with appliances 140A and 140B, respectively, to allow messages to be transported quickly between the appliances 140. In one embodiment, messaging applications 410A and 410B are implemented as ASP.NET applications and rely on signalR WebSockets to accomplish fast, real-time messaging.

Centralized cache and storage 420 provide a persistent messaging back-end through which messages can be exchanged between messaging applications 410A and 410B. In one embodiment, centralized cache and storage includes a Redis cache backed by a SQL database. Messaging applications 410A and 410B may be configured to periodically poll centralized cache and storage 420 for new messages, thereby allowing messages to be delivered to those applications quickly.

In operation, when display system 100A transmits a message indicating that content stream A is available on streaming infrastructure, as described above, display system 100A transmits that message to messaging application 410A. Messaging application 410A may then relay the message to centralized cache and storage 420. Messaging application 410B polls centralized cache and storage 420 periodically, and may thus determine that that the message has arrived. Messaging application 410B then relays the message to display system 100B. Display system 100B may then parse the message to retrieve an identifier associated with display system 100A, and then stream content associated with display system 100A from streaming server.

### Descriptor Overlay Feature

FIG. 5 is a conceptual diagram of the collaboration system 500 of FIG. 2 configured to display a descriptor overlay on an asset in a shared workspace, according to various embodiments of the present invention.

As shown, collaboration system 500 includes, without limitation, a communication infrastructure 210 connected with one or more display systems 100 (such as 100A and 100B), each display system 100 comprising an appliance/client 140 (such as 140A and 140B, respectively) and a display 120 (such as 120A, and 120B, respectively). Each appliance 140 comprises a client computing device that includes a central controller 110 (not shown) executing a client application 250 (such as 250A and 250B). As used herein, an appliance 140 may be referred to as a client device and these terms may be used interchangeably. For example, an appliance 140 may comprise a workstation, a laptop computer, a tablet, cell phone or other hand-held device, or any other type of computing device.

As described above in relation to FIGS. 1-4, the communication infrastructure 210 may store one or more projects 501, each project 501 comprising a set of one or more associated workspaces 502. Each shared workspace 502 may include one or more associated assets 503. For example, the projects 501, workspaces 502, and assets 503 may be stored in the collaboration server 310, database server 320, and/or file server 330 of the communication infrastructure 210. As described above, during a collaborative session, the communication infrastructure 210 may work in conjunction with the appliances 140 to share and display a shared workspace 502 of a project 501 across multiple display systems 100. Each appliance 140 in the collaborative session may display one or more assets 503 of the shared workspace 502 according to the asset metadata/information (stored to the communication infrastructure 210) associated with each asset 503. The communication infrastructure 210 may also work in conjunction with the appliances 140 to mirror user interactions of assets 503 of the shared workspace 502 at any appliance 140 across the multiple display systems 100 and appliances 140. For example, a user interaction of an asset (e.g., moving or resizing the asset) at a first appliance 140A is displayed/reflected at the first appliance 140A and also is displayed/reflected at the second appliance 140A via the communication infrastructure 210.

In some embodiments, the communication infrastructure 210 also executes an asset display engine 510 that manages and maintains an asset display data structure 620 for each shared workspace 502 of a project 501. In these embodiments, the asset display data structure 620 includes asset information (asset metadata) and overlay information for each asset in the shared workspace.

The asset information is used to determine and configure the display appearance of the assets within the shared workspace and is used by a client application 250 of an appliance 140 to locally display the assets within the workspace according to the asset information. In some embodiments, for each asset of a workspace, the asset display data structure 620 may contain asset information specifying the display aspect ratio, position, and size of the asset. For example, the asset information may include aspect ratio values, x and y coordinate position values and height and width size values for each asset in the workspace. In further embodiments, the asset information may include a page number for a currently displayed page of an asset and a total number of pages of an asset. For an asset comprising digital content that distributed over a single page, these values may default to a value of 1.

The overlay information determines and configures the display appearance of descriptor overlays superimposed on assets of the workspace and is used by a client application 250 of an appliance 140 to locally display the descriptor overlays on the assets of the workspace according to the overlay information. A descriptor overlay for an asset may be displayed within a presentation window (bounding box) that is displayed on top of (superimposed over) the asset. For simplicity, a descriptor overlay and the corresponding presentation window are generally referred to herein as a single entity, i.e., a “descriptor overlay.” Generally, the overlay information may specify a display position and size of the descriptor overlay on a corresponding asset within the shared workspace and at least one descriptor of the asset.

In some embodiments, the descriptor overlay is displayed over a predetermined portion of the corresponding asset. For example, the descriptor overlay may be displayed over a far bottom, far top, or far side portion of the corresponding asset. When displayed over a far bottom portion of the corresponding asset, the descriptor overlay may span the entire width of the asset but only span a predetermined percentage (e.g., 2%, 5%, 10%, etc.) of the height of the asset from the bottom of the asset. When displayed over a far top portion of the corresponding asset, the descriptor overlay may span the entire width of the asset but only span a predetermined percentage (e.g., 2%, 5%, 10%, etc.) of the height of the asset from the top of the asset. When displayed over a far side portion (left or right side) of the corresponding asset, the descriptor overlay may span the entire height of the asset but only span a predetermined percentage (e.g., 2%, 5%, 10%, etc.) of the width of the asset from the side of the asset.

The overlay information for an asset may specify a display position and display size of the corresponding descriptor overlay within the shared workspace by implementing horizontal and vertical (x and y) coordinate values. The position values (x and y coordinate values) for the descriptor overlay may correspond to a predetermined point on the descriptor overlay, such as the position of the upper left corner of the descriptor overlay. The size values for the descriptor overlay may be expressed as width and height values. As described above, asset information for an asset may specify a display position and display size of the asset within the shared workspace. The display position and display size of the corresponding descriptor overlay within the shared workspace may then be determined based on the display position and display size of the corresponding asset and the predetermined portion (far bottom, far top, or far side) of the corresponding asset over which the descriptor overlay is configured to be displayed.

In addition, the overlay information for an asset may specify at least one descriptor of the asset that is to be displayed in the corresponding descriptor overlay superimposed over the asset. Descriptors for an asset may comprise metadata describing the asset and comprises various relevant information related to the asset. Therefore, the descriptors for an asset displayed in the corresponding descriptor overlay provide exposed information describing the asset so that participants of a collaborative session may quickly distinguish the asset from other assets in the workspace. In some embodiments, descriptors of the asset may include an asset ID/name, source type, file type, a captured image indicator, a current page and total page, and a timestamp. The asset ID/name (“AID”) for an asset uniquely identifies the asset within the shared workspace. The source type (“ST”) of an asset specifies the type of content source of the asset (such as a file-based content source, an application-based content source, or Live Source). For an asset comprising a file-based content source, the file type (“FT”) of the asset specifies the native file type of the file-based source (such as pdf, doc, xls, etc.). The captured image indicator (“CI”) for an asset specifies whether the asset comprises a captured image of a content source (as opposed to an actual content source). For example, if the asset comprises a captured image of a content source, the captured image indicator may specify “Capture Image,” “SnapShot,” or the like. If the asset does not comprise a captured image of a content source but rather comprises a content source, the captured image indicator may specify “Content Source” or the like. The current page (“CP”) specifies the currently displayed page of the asset and the total page (“TP”) specifies the total number of pages of the asset. For an asset that is file-based and comprises an image file representation (e.g., JPEG representation) of the file, the current page (“CP”) specifies the currently displayed page of imaged representation of the asset and the total page (“TP”) specifies the total number of pages of image representations of the asset. For an asset comprising digital content that distributed over a single page, the current page and total page values may default to 1 or be blank or present some other information suggesting a single page asset. The timestamp (“TS”) for the asset specifies that date the asset is added to the shared workspace. In other embodiments, the asset descriptors include other types of metadata describing the asset.

The asset display engine 510 may reside and execute within the collaboration server 310 and the asset display data structure 620 may be stored on the collaboration server 310 and/or the database server 320. In another implementation, the asset display engine 510 may reside on a client device. The communication infrastructure 210 (via the asset display engine 510) may maintain and update an asset display data structure 620 for each shared workspace 502 of each project 501 during collaborative sessions for the project 501. The communication infrastructure 210 (via the asset display engine 510) may update an asset display data structure 620 for a shared workspace 502 to reflect user interactions with assets 503 of the shared workspace 502 during the session for a project 501. The communication infrastructure 210 may also persist/store the asset display data structure 620 of each shared workspace 502 of each project 501 so that the last state of the asset display data structure 620 prior to the closing/ending of the session is retained for the next session either individually for each workspace uniquely within a project or across all workspaces within a project.

The communication infrastructure 210 may transmit the asset display data structure 620 to each of the appliances 140 executing a client application 250. In turn, each client application 250 of an appliance 140 then displays/renders the shared workspace and the assets and descriptor overlays contained therein in the display 120 according to the asset display data structure 620. In response to each user interaction of an asset in the shared workspace at any of the appliances 140, the communication infrastructure 210 may update the asset display data structure 620 according to the user interaction and transmit the updated asset display data structure 620 to each of the appliances 140. In turn, each of the appliances 140 then displays/renders the shared workspace and the assets and descriptor overlays contained therein in the display 120 according to the updated asset display data structure 620. In this manner, user interactions and changes to the assets and descriptor overlays at any of the appliances 140 is mirrored to the other appliances 140 so that all appliances 140 in the session display the user interactions and changes to the assets and descriptor overlays. In some embodiments, each client application 250 of an appliance 140 may include a user selectable toggle feature that allows the user to turn the descriptor overlay feature “on” (whereby descriptor overlays are displayed over corresponding assets) or “off” (whereby descriptor overlays are not displayed over corresponding assets).

In this regard, a collaborative session may be considered a sequence of temporal renderings of the workspace, each rendering being a distinct temporal rendering of the workspace. For example, a new temporal rendering of the workspace may be caused to be produced after and in response to the communication infrastructure 210 receiving a user interaction with an asset of the workspace at any of the appliances 140, and then updating the asset display data structure 620 according to the received user interaction. User interactions may include, for example, moving and/or resizing an asset, selecting a new page of an asset to be displayed, and the like. Each new temporal rendering of the workspace is then generated at each appliance 140 based on the updated asset display data structure 620.

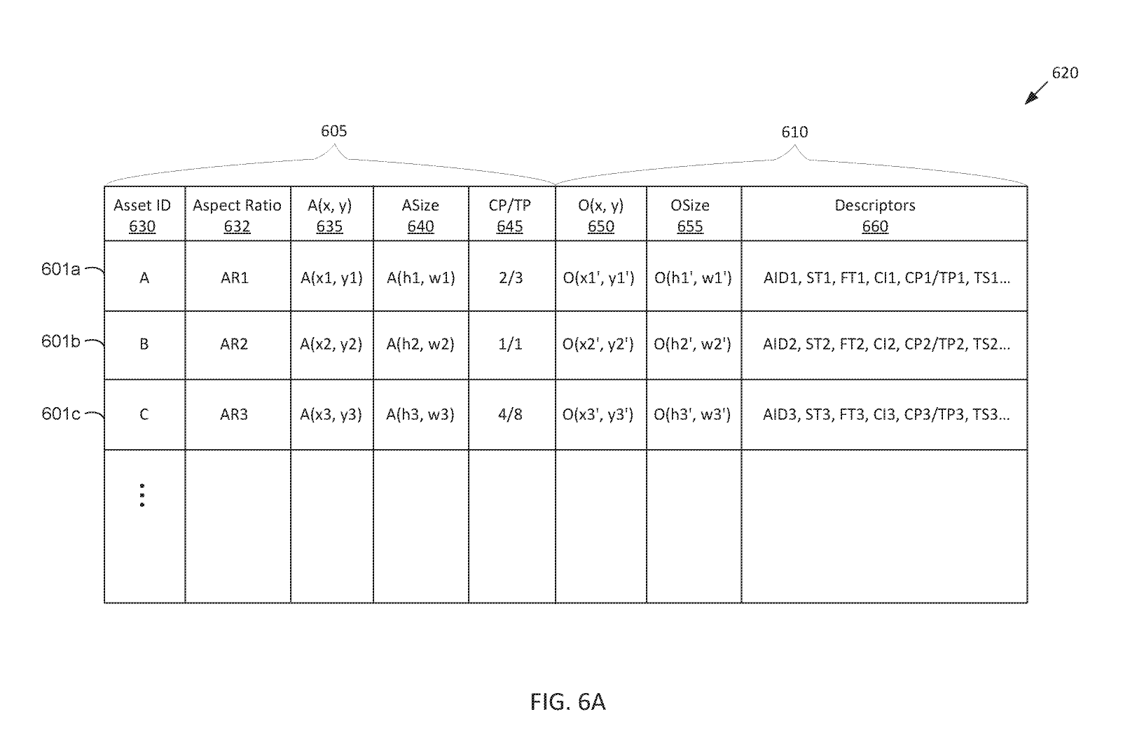

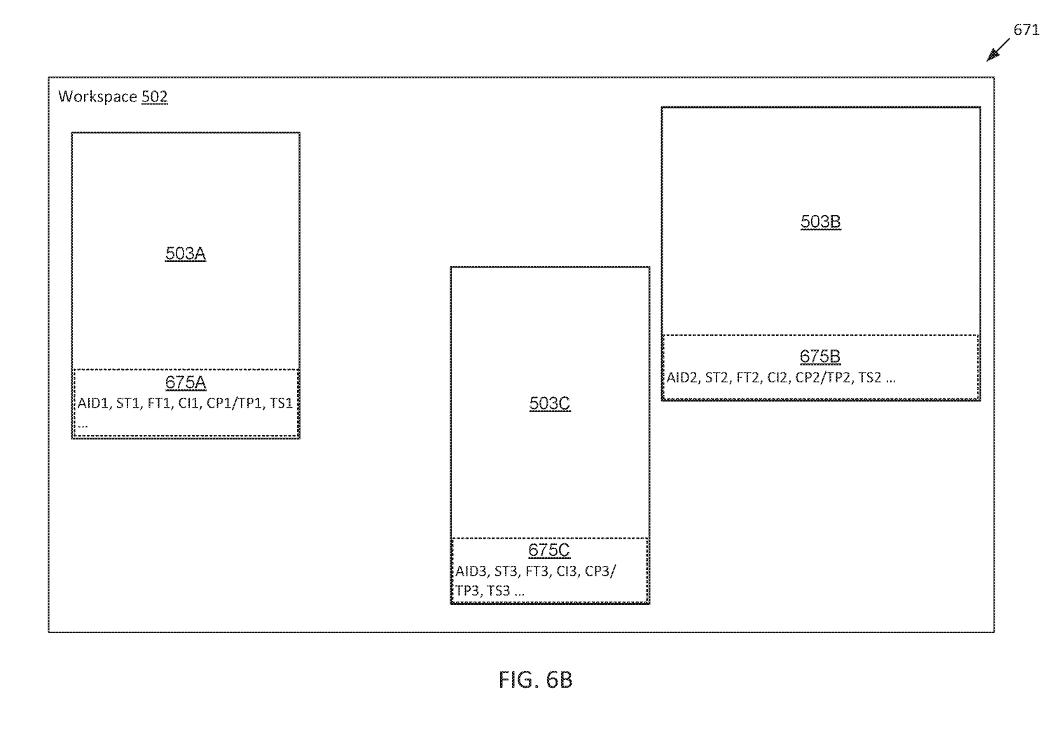

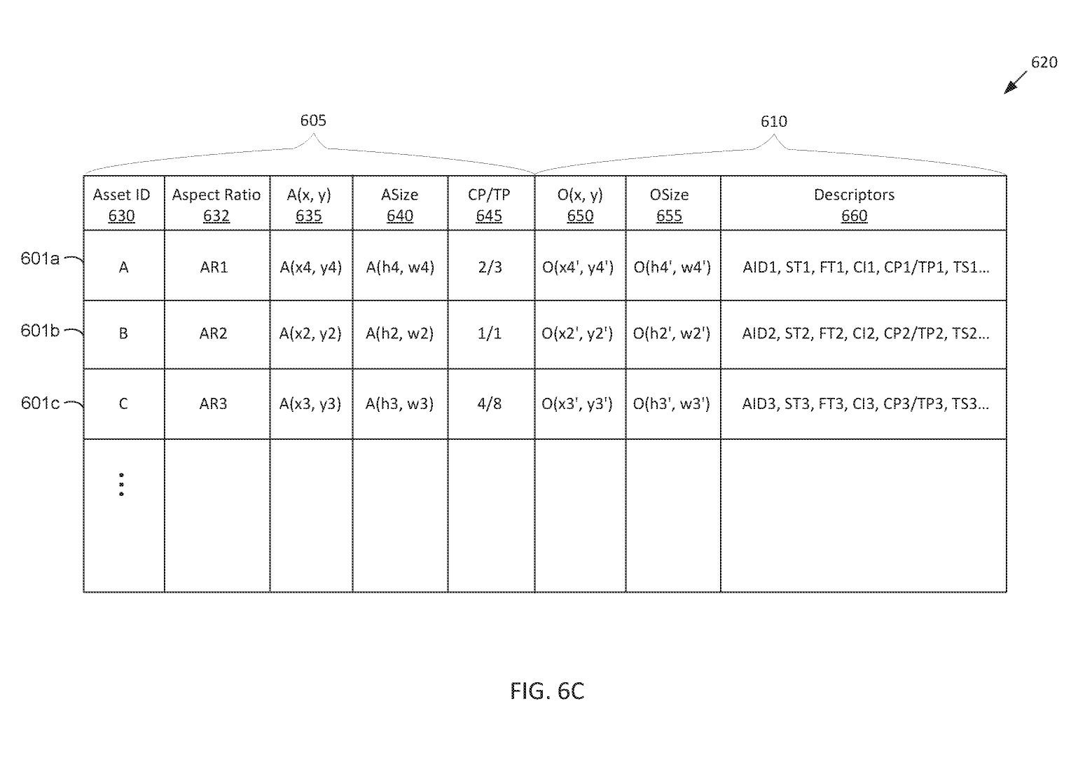

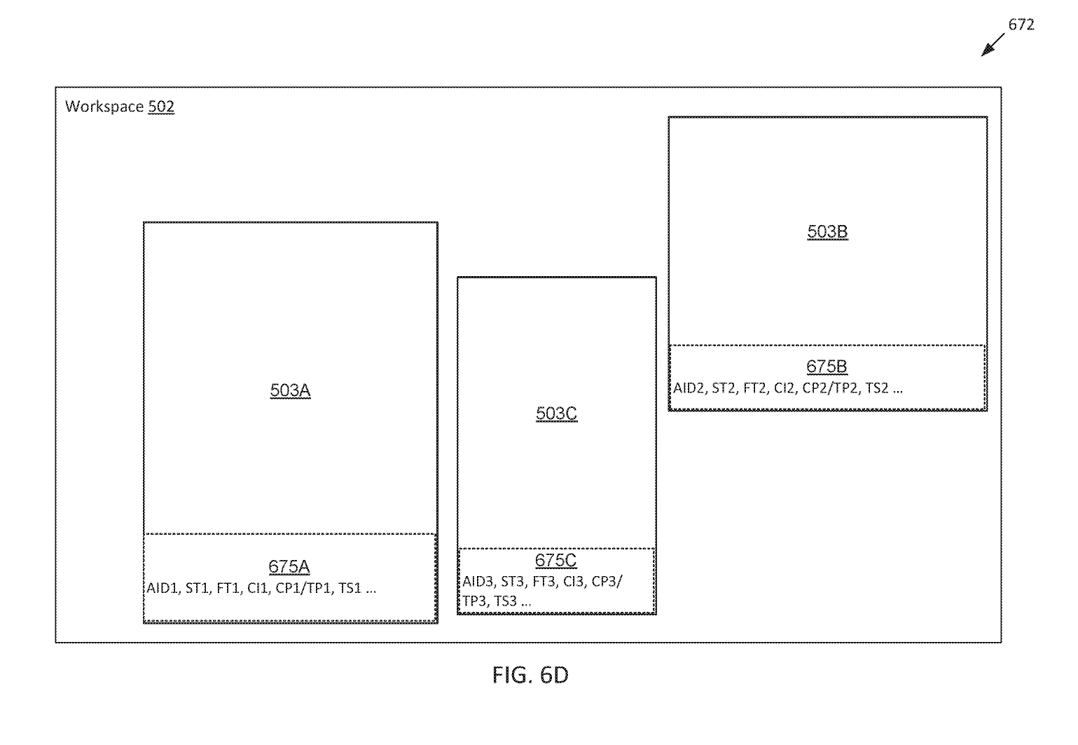

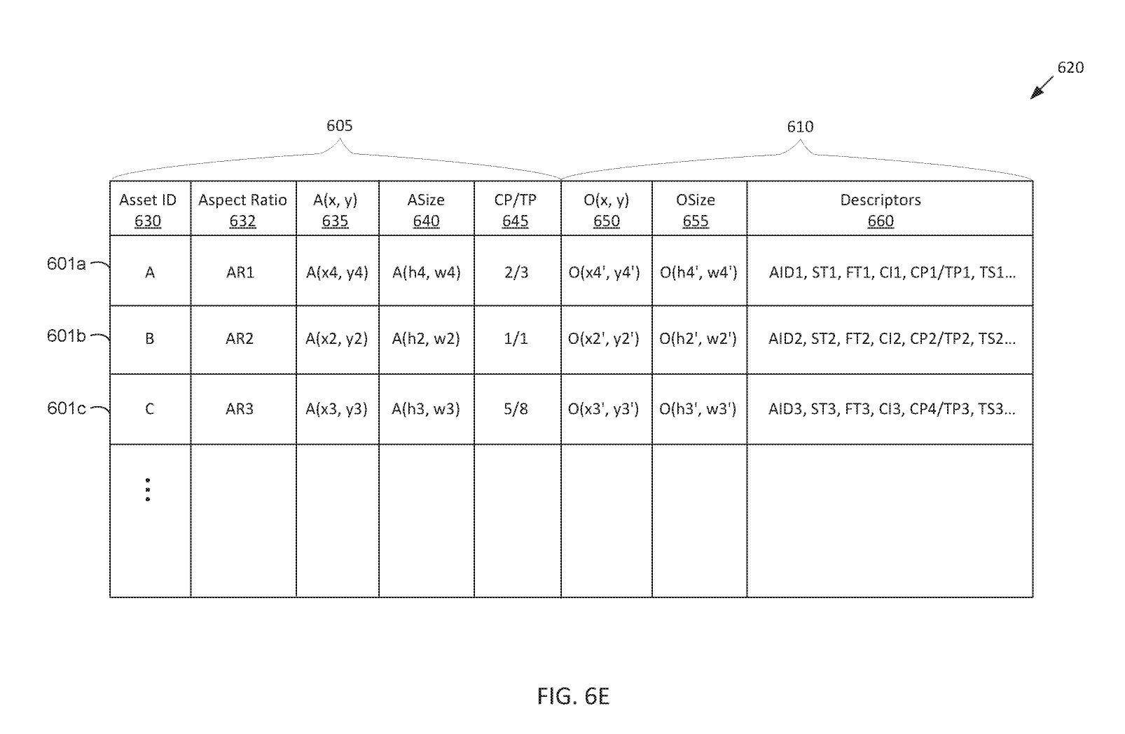

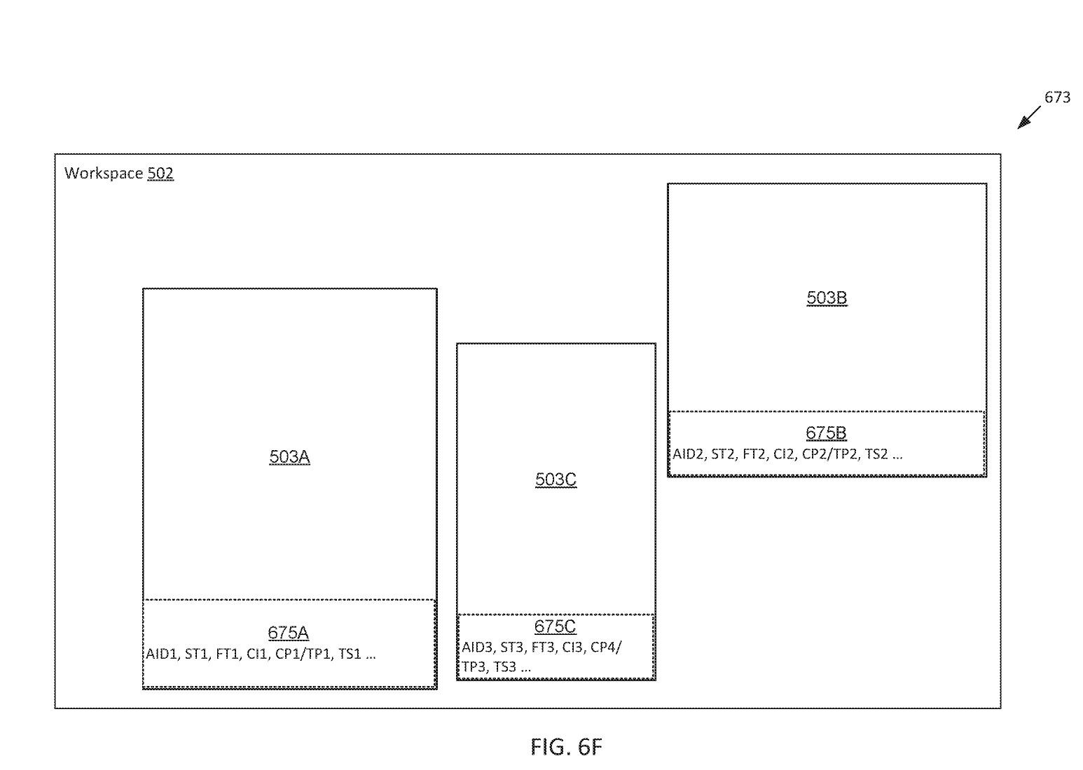

As described below, FIGS. 6A-6F show and describe exemplary screenshots of a sequence of renderings of a shared workspace 502 (and assets and descriptor overlays contained therein) and updates made to the asset display data structure 620. Each rendering shown in the Figures described below may comprise a distinct temporal rendering of the shared workspace 502. The below sequence of renderings is provided for illustrative purposes to illustrate a descriptor overlay feature of the shared workspace 502. In other embodiments, however, other sequences of workspace renderings may be used.

FIG. 6A is a conceptual diagram of an initial/first asset display data structure 620, according to various embodiments of the present invention. For example, the first asset display data structure 620 may be retrieved by the communication infrastructure 210 (e.g., from the collaboration server 310 or database server 320) at the start of a collaborative session for a particular shared workspace 502 and transmitted to each appliance 140 participating in the collaborative session.

As shown, the first asset display data structure 620 comprises a plurality of entries 601, each entry 601 representing a particular asset 503 associated with the shared workspace 502. For example, the plurality of entries 601 may include an entry for each of assets A (503A), B (503B), and C (503C) associated with the shared workspace 502. Each entry 601 contains asset information 605 and overlay information 610.

In some embodiments, the asset information 605 comprises a plurality of data fields including asset ID 630, aspect ratio 632, asset position (expressed as x, y coordinates) 635, asset size (expressed as height and width values) 640, and current page (CP)/total page (TP) 645. The asset ID 630 may uniquely identify the asset within the workspace. The aspect ratio 632 specifies the display aspect ratio for the asset. The asset position 635 indicates the position of the asset within the workspace (such as x and y pixel coordinates of the upper left corner of the asset in reference to a reference pixel point within the display device in combination with how the display device is positioning/rendering the workspace). The asset size 640 indicates the size of the asset within the workspace (such as height and width pixel values of the asset). The asset position 635 and asset size 640 may determine the position and size of the asset when displayed/rendered in the shared workspace at each appliance 140. The current page (CP) specifies the page number of the asset currently displayed in the shared workspace and the total page (TP) 645 specifies the total number of pages of the asset.

In some embodiments, the overlay information 610 comprises a plurality of data fields including overlay position (expressed as x, y coordinates) 650, overlay size (expressed as height and width values) 655, and asset descriptors 660. The overlay position 650 indicates the position of the descriptor overlay within the workspace (such as x and y pixel coordinates of the upper left corner of the descriptor overlay). The overlay size 655 indicates the size of the descriptor overlay within the workspace (such as height and width pixel values of the descriptor overlay). The overlay position 650 and overlay size 655 may determine the position and size of the descriptor overlay when displayed/rendered in the shared workspace at each appliance 140. The overlay position 650 and overlay size 655 of the descriptor overlay within the shared workspace may be determined based on the asset position 635 and asset size 640 of the corresponding asset. Thus, the overlay position 650 and overlay size 655 of the descriptor overlay is derived from the asset position 635 and asset size 640 of the corresponding asset. The overlay position 650 and overlay size 655 of the descriptor overlay within the shared workspace is also determined based on the predetermined portion (far bottom, far top, or far side) of the corresponding asset over which the descriptor overlay is configured to be displayed. In some embodiments, the overlay position 650 and overlay size 655 configure the descriptor overlay to be displayed/superimposed over the predetermined portion of the corresponding asset. In some embodiments, the asset descriptors 660 may comprise metadata descriptors of the asset including an asset ID (AID), source type (ST), file type (FT), a captured image indicator (CI), a current page and total page (CP/TP), and a timestamp (TS). In other embodiments, the asset descriptors 660 comprise other types of metadata descriptors of the asset.

Each client application 250 of an appliance 140 may receive (from the communication infrastructure 210) the first asset display data structure 620 and display/render the shared workspace 502 and the assets and descriptor overlays contained according to the first asset display data structure 620. FIG. 6B is a screenshot 671 of a first temporal rendering of a shared workspace 502 based on the first asset display data structure 620 of FIG. 6A, according to various embodiments of the present invention. The assets A (503A), B (503B), and C (503C) are displayed within the shared workspace 502 according to the asset information 605 (such as aspect ratio 632, asset position 635, asset size 640, and current page 645 fields) contained in the first asset display data structure 620.

In addition, a descriptor overlay 675 is displayed over a predetermined portion of a corresponding asset 503 according to the overlay information 610 (such as overlay position 650 and overlay size 655 fields) contained in the first asset display data structure 620. For example, a descriptor overlay A (675A) is superimposed over the bottom portion of asset A (503A), a descriptor overlay B (675B) is superimposed over the bottom portion of asset B (503B), and a descriptor overlay C (675C) is superimposed over the bottom portion of asset C (503C). In the example shown in FIG. 6B, the descriptor overlays 675 are configured to be displayed over the bottom portion of the corresponding assets 503. In other embodiments, however, the descriptor overlays 675 may be configured to be displayed over a different portion of the corresponding assets 503 (such as a top, right, or left portion). Each descriptor overlay 675 displays at least one metadata descriptor describing the asset, such as asset ID (AID), source type (ST), file type (FT), a captured image indicator (CI), a current page and total page (CP/TP), and a timestamp (TS).

In some embodiments, a descriptor overlay 675 may be assigned a transparency value that allows at least a portion of the corresponding asset 503 (over which the descriptor overlay 675 is superimposed) to be partially visible underneath the descriptor overlay 675. In these embodiments, the descriptor overlay 675 is not displayed with a solid color background, and any areas in the descriptor overlay 675 that do not contain content can be layered with a transparency to allow the corresponding asset 503 beneath areas of the descriptor overlay 675 not having content to be partially visible. For example, a visual contrast may be created between the descriptor overlay 675 and the corresponding asset 503, such as a descriptor overlay 675 configured with a semi-transparent dark (e.g., black or dark gray) background with brighter (e.g., white) text displayed on top of the darker background.

In some embodiments, each client application 250 of an appliance 140 may include a user selectable toggle feature that allows the user to turn the descriptor overlay feature “on” (whereby descriptor overlays 675 are displayed over corresponding assets 503) or “off” (whereby descriptor overlays 675 are not displayed over corresponding assets 503).

After each appliance 140 receives and displays the shared workspace according to the initial/first asset display data structure 620 at the start of a collaborative session, a user at any appliance 140 may then interact with and modify an asset 503 displayed in the shared workspace 502. For example, the user may reposition (move) and/or resize an asset 503 within the shared workspace 502 or select a new page to be displayed for an asset 503. The communication infrastructure 210 (via the asset display engine 510) may detect such user interactions with assets 503 and update the asset display data structure 620 to reflect the detected user interactions. The communication infrastructure 210 may then transmit the updated asset display data structure 620 to each appliance 140 in the collaborative session, whereby each appliance 140 then displays the updated shared workspace 502 according to the updated asset display data structure 620. In this manner, user interactions with assets at each appliance 140 may be reflected/mirrored to each of the other appliances 140 in the collaborative session.

For example, a user at an appliance 140 may interact with asset A (503A) by moving and resizing asset A to have a new position and size within the shared workspace 502. The communication infrastructure 210 may receive and detect the user interaction and update the asset display data structure 620 to reflect the user interaction. FIG. 6C is a conceptual diagram of an updated second asset display data structure 620, according to various embodiments of the present invention. In the example of FIG. 6C, the asset display data structure 620 is updated to reflect the new position and size of asset A (503A) within the shared workspace 502. As shown, the entry 601a representing asset A is updated with new values for the asset position 635 and asset size 640 fields. Note that the user at an appliance 140 may interact with an asset to only move the asset to a new position (whereby only the asset position 635 is updated) or only resize the asset to a new size (whereby only the asset size 640 is updated). When a user resizes an asset, the client application 250 may enforce the assigned aspect ratio 632 for the asset. Consequently, the new height and width dimensions of the asset from the resizing will be consistent and conform with the assigned aspect ratio 632.

In addition, the entry 601a representing asset A is updated with new values for the overlay position 650 and overlay size 655 based on the updated asset position 635 and asset size 640 fields. Thus, the overlay position 650 and overlay size 655 of descriptor overlay A (675A) is determined based on the updated asset position 635 and asset size 640 of corresponding asset A (503). The updated overlay position 650 and overlay size 655 of descriptor overlay A is also determined based on the location of the predetermined portion (far bottom, far top, or far side) of the corresponding asset. The updated entry 601a representing asset A having updated values for the asset position 635, asset size 640, overlay position 650, and overlay size 655 fields produce an updated (second) asset display data structure 620. The communication infrastructure 210 may then transmit the second asset display data structure 620 to each appliance 140 in the collaborative session.

Each appliance 140 may receive (from the communication infrastructure 210) the second asset display data structure 620 and display/render the shared workspace 502 according to the second asset display data structure 620. FIG. 6D is a screenshot 672 of a second temporal rendering of a shared workspace 502 based on the second asset display data structure 620 of FIG. 6C, according to various embodiments of the present invention. As shown, asset A (503A) is now displayed/rendered with an updated position and size within the shared workspace 502. In addition, descriptor overlay A (675A) is now displayed/rendered with an updated position and size within the shared workspace 502. As shown, the descriptor overlay A continues to be superimposed over the predetermined bottom portion of corresponding asset A, the descriptor overlay A displaying at least one metadata descriptor for asset A.

For example, a user at an appliance 140 may then interact with asset C (503C) by selecting a new page of asset C to be displayed in the shared workspace 502. The communication infrastructure 210 may receive and detect the user interaction and update the asset display data structure 620 to reflect the user interaction. FIG. 6E is a conceptual diagram of an updated third asset display data structure 620, according to various embodiments of the present invention. In the example of FIG. 6E, the entry 601c representing asset C is updated with a new value for the current displayed page (CP) 645 field. In addition, the entry 601c is updated with a new value for current page and total page (CP/TP) within the asset descriptors 660 field to reflect the new currently displayed page of the asset. The updated entry 601c representing asset C produces an updated (third) asset display data structure 620. The communication infrastructure 210 may then transmit the third asset display data structure 620 to each appliance 140 in the collaborative session.

Each appliance 140 may receive (from the communication infrastructure 210) the third asset display data structure 620 and display/render the shared workspace 502 according to the third asset display data structure 620. FIG. 6F is a screenshot 673 of a third temporal rendering of a shared workspace 502 based on the third asset display data structure 620 of FIG. 6E, according to various embodiments of the present invention. As shown, descriptor overlay C (675C) is now displayed with an updated value for the new currently displayed page (CP/TP) descriptor of asset C (503C).

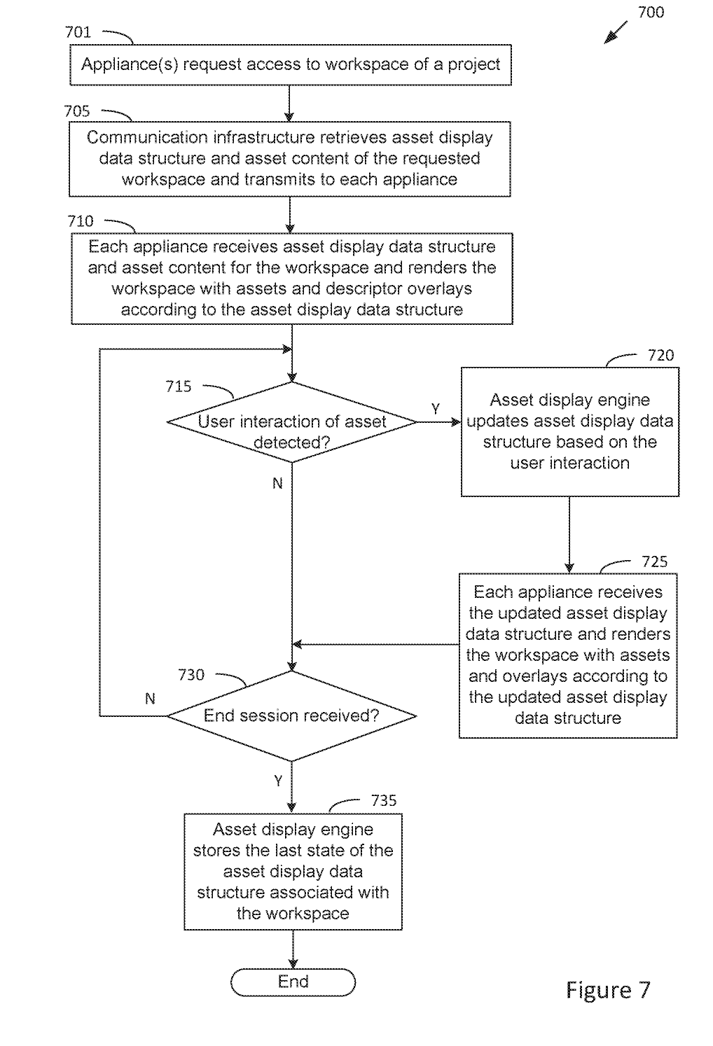

FIG. 7 sets forth a flow diagram of method steps for displaying descriptor overlays in a shared workspace, according to various embodiments of the present invention. Although the method steps are described in conjunction with the systems of FIGS. 1-6F, persons skilled in the art will understand that any system configured to perform the method steps, in any order, is within the scope of the present invention.

For context, in various embodiments, the communication infrastructure 210 (comprising an asset display engine 510) may operate in conjunction with one or more display systems 100 (each display system 100 comprising a display and an appliance 140 executing a client application 250) to perform the method steps of a method 700 of FIG. 7. The method 700 may be performed during a collaborative session whereby two or more appliances 140 may access and interact with a shared project and shared workspace via the communication infrastructure 210, the user interactions at each appliance 140 being mirrored/reflected at each of the appliances 140 participating in the collaborative session. In this regard, a collaborative session may be considered a sequence of temporal renderings of the shared workspace, each rendering being a distinct temporal rendering of the shared workspace at each appliance 140.

As shown, a method 700 begins at step 701, where a plurality of appliances 140 request access to a shared workspace 502 of a project 501 stored on the communication infrastructure 210 to begin the collaborative session. In response, the communication infrastructure 210 retrieves (at step 705) a last state of an asset display data structure 620 associated with the requested shared workspace 502 (e.g., retrieve from the collaboration server 310 and/or the database server 320). The communication infrastructure 210 may maintain and store an asset display data structure 620 for each shared workspace 502 of each project 501 during collaborative sessions for the project 501. The communication infrastructure 210 also retrieves (at step 705) the asset content 331 for one or more digital assets 503 of the requested shared workspace 502 (e.g., retrieve from the file server 330). The communication infrastructure 210 further transmits (at step 705) the asset display data structure 620 and the asset content 331 for the requested shared workspace 502 to each appliance 140 participating in the collaborative session.

At step 710, each appliance 140 then receives the asset display data structure 620 and the asset content 331 for the shared workspace 502 and displays/renders the shared workspace 502 and the assets 503 and descriptor overlays 675 contained therein according to the asset display data structure 620.

Each appliance 140 may render each asset 503 within the shared workspace 502 according to the aspect ratio 632, asset position 635, asset size 640, and current display page 645 fields of the asset information 605 stored in the asset display data structure 620. Each appliance 140 may also render each descriptor overlays 675 within the shared workspace 502 according to the overlay position 650, overlay size 655, and asset descriptor 660 fields of the overlay information 610 stored in the asset display data structure 620. The overlay position 650 and overlay size 655 fields of each descriptor overlay 675 may configure the descriptor overlay 675 to be displayed/rendered over a predetermined portion of the corresponding asset 503. Each descriptor overlay 675 may display at least one metadata descriptor of the asset (as specified in the asset descriptor 660 field). In some embodiments, each client application 250 of an appliance 140 may include a user selectable toggle feature that allows the user to turn the descriptor overlay feature “on” or “off.”

The asset display engine 510 then determines (at step 715) if a user interaction of any asset 503 (referred to as an “interacted asset”) in the shared workspace 502 is detected/received at any appliance 140. If not (at 715—No), the method 700 proceeds at step 730. If so (at 715—Yes), the asset display engine 510 updates the asset display data structure 620 based on the detected user interaction. User interactions may include, for example, moving and/or resizing an asset 503, selecting a new page of an asset 503 to be displayed, and the like. At step 725, each appliance 140 then receives the updated asset display data structure 620 and displays/renders the shared workspace 502 and the assets 503 and descriptor overlays 675 contained therein according to the updated asset display data structure 620.

The asset display engine 510 then determines (at step 730) if an “end session” request is received at any appliance 140. If not (at 730—No), the method 700 proceeds at step 715. If so (at step 730—Yes), the asset display engine 510 then stores (at step 735) the last state of the asset display data structure 620 associated with the shared workspace 502 (e.g., stores to the collaboration server 310 and/or the database server 320) so that the last state of the asset display data structure 620 and the shared workspace 502 persists to a next future session. The method 700 then ends.

In sum, a communication infrastructure 210 transmits an asset display data structure 620 to each appliance 140 in a collaborative session for a shared workspace 502. The asset display data structure 620 comprises asset information 605 (comprising aspect ratio, asset position, asset size, and current page fields) that configures the display appearance of assets 503 within the shared workspace 502. The asset display data structure 620 further comprises overlay information 610 (comprising overlay position, overlay size, and asset descriptor fields) that configures the display appearance of descriptor overlays 675 within the shared workspace 502. Each descriptor overlay 675 is configured to be displayed over a predetermined portion of the corresponding asset 503, the descriptor overlay 675 displaying at least one metadata descriptor of the corresponding asset 503. Each appliance 140 receives the asset display data structure 620 and displays/renders the shared workspace 502 and the assets 503 and descriptor overlays 675 contained therein according to the received asset display data structure 620.

At least one advantage of the disclosed technique is that descriptors for an asset of a shared workspace are superimposed on an asset as an overlay, thus providing exposed information describing the asset to a plurality of clients in a collaborative session. The exposed descriptors may be used by participants to quickly distinguish the asset from other assets in the workspace at a glance during the collaborative session.

Aspects of the subject matter described herein are set out in the following numbered any of clauses.

1. A computer-implemented method for displaying asset descriptors in a shared workspace, the method comprising: retrieving an asset data structure associated with the shared workspace, the asset data structure comprising asset information and overlay information for a first asset included in the shared workspace, the asset information specifying a display position and display size of the first asset within the shared workspace, and the overlay information specifying a display position and display size within the workspace of a first overlay associated with the first asset, the first overlay including at least one descriptor of the first asset; and transmitting the asset data structure to a plurality of clients in a collaborative session for the shared workspace, wherein a display device of each client displays the first asset within the display device's display of the shared workspace and displays the first overlay on or proximate to the first asset according to the received asset data structure.

2. The computer-implemented method of clause 1, wherein: the first asset comprises at least one of a content source and a captured image of a content source; and the at least one descriptor specifies whether the first asset comprises a content source or a captured image of a content source.

3. The computer-implemented method of any of clauses 1-2, wherein: the first asset comprises a file-based source; and the at least one descriptor specifies a file type of the file-based source.

4. The computer-implemented method of any of clauses 1-3, wherein: the first asset comprises digital content distributed across a plurality of pages; and the at least one descriptor specifies a currently displayed page number of the current rendering of the first asset and a total number of pages of the first asset.

5. The computer-implemented method of any of clauses 1-4, wherein the at least one descriptor specifies at least one of an asset name that uniquely identifies the first asset within the shared workspace and a timestamp that indicates a date on when the first asset was added to the shared workspace.

6. The computer-implemented method of any of clauses 1-5, wherein the display position and display size of the first overlay are based on the display position and display size of the first asset.

7. The computer-implemented method of any of clauses 1-6, wherein: the display position and display size of the first overlay contributes to configuring the first overlay to be displayed on a predetermined portion of the first asset; and the first overlay is displayed on the predetermined portion of the first asset at each client included in the plurality of clients.

8. The computer-implemented method of any of clauses 1-7, further comprising: detecting an interaction with the first asset in the shared workspace, the interaction comprising a repositioning of the first asset to an updated display position within the shared workspace; generating an updated asset data structure comprising updated asset information and updated overlay information for the first asset, the updated asset information specifying the updated display position of the first asset within the shared workspace and the updated overlay information specifying an updated display position of the first overlay on the first asset; and transmitting the updated asset data structure to each of the plurality of clients in the collaborative session, wherein each of the plurality of clients displays the shared workspace by displaying the first asset and the first overlay within the shared workspace according to the updated asset data structure.

9. The computer-implemented method of any of clauses 1-8, further comprising: detecting an interaction with the first asset in the shared workspace, the interaction comprising a resizing of the first asset to an updated display size within the shared workspace; generating an updated asset data structure comprising updated asset information and updated overlay information for the first asset, the updated asset information specifying the updated display size of the first asset within the shared workspace and the updated overlay information specifying an updated display size of the first overlay on the first asset; and transmitting the updated asset data structure to each of the plurality of clients in the collaborative session, wherein each of the plurality of clients displays the shared workspace by displaying the first asset and the first overlay within the shared workspace according to the updated asset data structure.

10. The computer-implemented method of any of clauses 1-9, wherein an asset comprises digital content distributed across a plurality of pages, and the at least one descriptor of the first asset specifies a currently displayed page number associated with the first asset, the method further comprising: detecting an interaction with the first asset in the shared workspace, the interaction comprising selection of an updated currently displayed page number of the first asset; generating an updated asset data structure comprising updated overlay information for the first asset specifying the updated currently displayed page number of the first asset; and transmitting the updated asset data structure to each of the plurality of clients in the collaborative session, wherein each of the plurality of clients displays the shared workspace by displaying the first asset and the first overlay within the shared workspace according to the updated asset data structure.

11. A non-transitory computer-readable medium storing program instructions that, when executed by a processor, cause the processor to display asset descriptors in a shared workspace, by performing the steps of: retrieving an asset data structure associated with the shared workspace, the asset data structure comprising asset information and overlay information for a first asset included in the shared workspace, the asset information specifying a display position and display size of the first asset within the shared workspace, and the overlay information specifying a display position and display size within the workspace of a first overlay associated with the first asset; the first overlay including at least one descriptor of the first asset; and transmitting the asset data structure to a plurality of clients in a collaborative session for the shared workspace, wherein a display device of each client displays the first asset within the display device's display of the shared workspace and displays the first overlay on or proximate to the first asset according to the received asset data structure.

12. The non-transitory computer-readable medium of clause 11, wherein: the first asset comprises at least one of a content source and a captured image of a content source; and the at least one descriptor specifies whether the first asset comprises a content source or a captured image of a content source.

13. The non-transitory computer-readable medium of any of clauses 11-12, wherein: the first asset comprises a content source comprising at least one of a file-based content source, application-based content source, and Live Source; and the at least one descriptor specifies the type of content source comprising the first asset.

14. The non-transitory computer-readable medium of any of clauses 11-13, wherein: the first asset comprises digital content distributed across a plurality of pages; and the at least one descriptor specifies a currently displayed page number of the current rendering of the first asset and a total number of pages of the first asset.

15. The non-transitory computer-readable medium of any of clauses 11-14, wherein the display position and display size of the first overlay are based on the display position and display size of the first asset and a predetermined portion of the first asset over which the first overlay is displayed.

16. The non-transitory computer-readable medium of any of clauses 11-15, wherein the predetermined portion of the first asset comprises a far bottom, far top, or far side portion of the first asset.

17. The non-transitory computer-readable medium of any of clauses 11-16, further comprising: detecting an interaction with the first asset in the shared workspace, the interaction comprising a repositioning of the first asset to an updated display position within the shared workspace; generating an updated asset data structure comprising updated asset information and updated overlay information for the first asset, the updated asset information specifying the updated display position of the first asset within the shared workspace and the updated overlay information specifying an updated display position of the first overlay on the first asset; and transmitting the updated asset data structure to each of the plurality of clients in the collaborative session, wherein each of the plurality of clients displays the shared workspace by displaying the first asset and the first overlay within the shared workspace according to the updated asset data structure.

18. The non-transitory computer-readable medium of any of clauses 11-17, further comprising: detecting an interaction with the first asset in the shared workspace, the interaction comprising a resizing of the first asset to an updated display size within the shared workspace; generating an updated asset data structure comprising updated asset information and updated overlay information for the first asset, the updated asset information specifying the updated display size of the first asset within the shared workspace and the updated overlay information specifying an updated display size of the first overlay on the first asset; and transmitting the updated asset data structure to each of the plurality of clients in the collaborative session, wherein each of the plurality of clients displays the shared workspace by displaying the first asset and the first overlay within the shared workspace according to the updated asset data structure.

19. A system configured for displaying asset descriptors in a shared workspace, the system comprising: a communication infrastructure comprising: a memory that includes an asset display engine; and a processor coupled to the memory, wherein, upon executing the asset display engine, is configured to: retrieving an asset data structure associated with the shared workspace, the asset data structure comprising asset information and overlay information for a first asset included in the shared workspace, the asset information specifying a display position and display size of the first asset within the shared workspace, and the overlay information specifying a display position and display size within the workspace of a first overlay associated with the first asset, the first overlay including at least one descriptor of the first asset; and transmitting the asset data structure to a plurality of clients in a collaborative session for the shared workspace, wherein a display device of each client displays the first asset within the display device's display of the shared workspace and displays the first overlay on or proximate to the first asset according to the received asset data structure.

20. The system of clause 19, wherein: the first asset comprises at least one of a content source and a captured image of a content source; and the at least one descriptor specifies whether the first asset comprises a content source or a captured image of a content source.

21. The system of any of clauses 19-20, wherein: the first asset comprises digital content distributed across a plurality of pages; and the at least one descriptor specifies a currently displayed page number of the current rendering of the first asset and a total number of pages of the first asset.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” or “engine” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

The invention claimed is:

1. A computer-implemented method for displaying asset descriptors in a shared workspace, the method comprising:
retrieving an asset data structure associated with the shared workspace, the asset data structure comprising asset information and overlay information for a first asset included in the shared workspace; the asset information specifying a display position and display size of the first asset within the shared workspace, and the overlay information specifying a display position and display size within the workspace of a first overlay associated with the first asset, the first overlay including at least one descriptor of the first asset; and
transmitting the asset data structure to a plurality of clients in a collaborative session for the shared workspace, wherein a display device of each client displays the first asset within the display device's display of the shared workspace and displays the first overlay on or proximate to the first asset according to the received asset data structure.

2. The computer-implemented method of claim 1, wherein:
the first asset comprises at least one of a content source and a captured image of a content source; and
the at least one descriptor specifies whether the first asset comprises a content source or a captured image of a content source.

3. The computer-implemented method of claim 1, wherein:
the first asset comprises a file-based source; and
the at least one descriptor specifies a file type of the file-based source.

4. The computer-implemented method of claim 1, wherein:
the first asset comprises digital content distributed across a plurality of pages; and
the at least one descriptor specifies a currently displayed page number of the current rendering of the first asset and a total number of pages of the first asset.

5. The computer-implemented method of claim 1, wherein the at least one descriptor specifies at least one of an asset name that uniquely identifies the first asset within the shared workspace and a timestamp that indicates a date on when the first asset was added to the shared workspace.

6. The computer-implemented method of claim 1, wherein the display position and display size of the first overlay are based on the display position and display size of the first asset.

7. The computer-implemented method of claim 1, wherein:
the display position and display size of the first overlay contributes to configuring the first overlay to be displayed on a predetermined portion of the first asset; and
the first overlay is displayed on the predetermined portion of the first asset at each client included in the plurality of clients.

8. The computer-implemented method of claim 1, further comprising:
detecting an interaction with the first asset in the shared workspace, the interaction comprising a repositioning of the first asset to an updated display position within the shared workspace;
generating an updated asset data structure comprising updated asset information and updated overlay information for the first asset, the updated asset information specifying the updated display position of the first asset within the shared workspace and the updated overlay information specifying an updated display position of the first overlay on the first asset; and
transmitting the updated asset data structure to each of the plurality of clients in the collaborative session, wherein each of the plurality of clients displays the shared workspace by displaying the first asset and the first overlay within the shared workspace according to the updated asset data structure.

9. The computer-implemented method of claim 1, further comprising:
detecting an interaction with the first asset in the shared workspace, the interaction comprising a resizing of the first asset to an updated display size within the shared workspace;
generating an updated asset data structure comprising updated asset information and updated overlay information for the first asset, the updated asset information specifying the updated display size of the first asset within the shared workspace and the updated overlay information specifying an updated display size of the first overlay on the first asset; and
transmitting the updated asset data structure to each of the plurality of clients in the collaborative session, wherein each of the plurality of clients displays the shared workspace by displaying the first asset and the first overlay within the shared workspace according to the updated asset data structure.

10. The computer-implemented method of claim 1, wherein an asset comprises digital content distributed across a plurality of pages, and the at least one descriptor of the first asset specifies a currently displayed page number associated with the first asset, the method further comprising:
detecting an interaction with the first asset in the shared workspace, the interaction comprising selection of an updated currently displayed page number of the first asset;
generating an updated asset data structure comprising updated overlay information for the first asset specifying the updated currently displayed page number of the first asset; and
transmitting the updated asset data structure to each of the plurality of clients in the collaborative session, wherein each of the plurality of clients displays the shared workspace by displaying the first asset and the first overlay within the shared workspace according to the updated asset data structure.

11. A non-transitory computer-readable medium storing program instructions that, when executed by a processor, cause the processor to display asset descriptors in a shared workspace, by performing the steps of:
retrieving an asset data structure associated with the shared workspace, the asset data structure comprising asset information and overlay information for a first asset included in the shared workspace, the asset information specifying a display position and display size of the first asset within the shared workspace, and the overlay information specifying a display position and display size within the workspace of a first overlay associated with the first asset, the first overlay including at least one descriptor of the first asset; and
transmitting the asset data structure to a plurality of clients in a collaborative session for the shared workspace, wherein a display device of each client displays the first asset within the display device's display of the shared workspace and displays the first overlay on or proximate to the first asset according to the received asset data structure.

12. The non-transitory computer-readable medium of claim 11, wherein:
the first asset comprises at least one of a content source and a captured image of a content source; and
the at east one descriptor specifies whether the first asset comprises a content source or a captured image of a content source.

13. The non-transitory computer-readable medium of claim 11, wherein:
the first asset comprises a content source comprising at least one of a file-based content source, application-based content source, and Live Source; and
the at least one descriptor specifies the type of content source comprising the first asset.

14. The non-transitory computer-readable medium of claim 11, wherein:
the first asset comprises digital content distributed across a plurality of pages; and
the at least one descriptor specifies a currently displayed page number of the current rendering of the first asset and a total number of pages of the first asset.

15. The non-transitory computer-readable medium of claim 11, wherein the display position and display size of the first overlay are based on the display position and display size of the first asset and a predetermined portion of the first asset over which the first overlay is displayed.

16. The non-transitory computer-readable medium of claim 15, wherein the predetermined portion of the first asset comprises a far bottom, far top, or far side portion of the first asset.

17. The non-transitory computer-readable medium of claim 11, further comprising:
detecting an interaction with the first asset in the shared workspace, the interaction comprising a repositioning of the first asset to an updated display position within the shared workspace;
generating an updated asset data structure comprising updated asset information and updated overlay information for the first asset, the updated asset information specifying the updated display position of the first asset within the shared workspace and the updated overlay information specifying an updated display position of the first overlay on the first asset; and
transmitting the updated asset data structure to each of the plurality of clients in the collaborative session, wherein each of the plurality of clients displays the shared workspace by displaying the first asset and the first overlay within the shared workspace according to the updated asset data structure.

18. The non-transitory computer-readable medium of claim 11, further comprising:
detecting an interaction with the first asset in the shared workspace, the interaction comprising a resizing of the first asset to an updated display size within the shared workspace;
generating an updated asset data structure comprising updated asset information and updated overlay information for the first asset, the updated asset information specifying the updated display size of the first asset within the shared workspace and the updated overlay information specifying an updated display size of the first overlay on the first asset; and
transmitting the updated asset data structure to each of the plurality of clients in the collaborative session, wherein each of the plurality of clients displays the shared workspace by displaying the first asset and the first overlay within the shared workspace according to the updated asset data structure.

19. A system configured for displaying asset descriptors in a shared workspace, the system comprising:
a communication infrastructure comprising:
a memory that includes an asset display engine; and
a processor coupled to the memory, wherein, upon executing the asset display engine, is configured to:
retrieving an asset data structure associated with the shared workspace, the asset data structure comprising asset information and overlay information for a first asset included in the shared workspace, the asset information specifying a display position and display size of the first asset within the shared workspace, and the overlay information specifying a display position and display size within the workspace of a first overlay associated with the first asset, the first overlay including at least one descriptor of the first asset; and
transmitting the asset data structure to a plurality of clients in a collaborative session for the shared workspace, wherein a display device of each client displays the first asset within the display device's display of the shared workspace and displays the first overlay on or proximate to the first asset according to the received asset data structure.

20. The system of claim 19, wherein:
the first asset comprises at least one of a content source and a captured image of a content source; and
the at least one descriptor specifies whether the first asset comprises a content source or a captured image of a content source.

21. The system of claim 19, wherein:
the first asset comprises digital content distributed across a plurality of pages; and
the at least one descriptor specifies a currently displayed page number of the current rendering of the first asset and a total number of pages of the first asset.
